(19) United States
(12) Patent Application Publication
(10) Pub. No.: US 2021/0248398 A1
(43) Pub. Date: Aug. 12, 2021

(54) METHOD FOR MONITORING THE LOAD COMPARTMENT IN A VEHICLE

(71) Applicant: WABCO Europe BVBA, Brussels (BE)

(72) Inventors: Umut Gencaslan, Hannover (DE); Thomas Wolf, Barsinghausen (DE); Dennis Buchner, Sarstedt (DE); Tobias Klinger, Springe (DE); Daniel Pfefferkorn, Hannover (DE); Gandert Marcel Rita Van Raemdonck, PW Delft (NL)

(21) Appl. No.: 17/269,274

(22) PCT Filed: Jun. 28, 2019
(86) PCT No.: PCT/EP2019/067281

§ 371 Date: Feb. 18, 2021

(30) Foreign Application Priority Data
Aug. 21, 2018 (DE) 10 2018 120 333.0

(51) Int. Cl. G06K 9/00; B60W 50/14

(52) U.S. Cl. CPC G06K 9/00832; B60W 2050/146; B60W 50/14

(57) ABSTRACT

A method for monitoring a load compartment (14) in a vehicle (10) uses an optical sensor (21) installed in the load compartment (14), a computer system with software for image processing and a graphical user interface. According to the method, a grid R of the cargo load compartment is stored in the computer system. An image I(t₁) captured by the optical sensor (21) at a time t₁ is converted in the computer system into a grid image RI which shows the occupancy, non-occupancy or change of occupancy of the load compartment according to the stored grid R. The grid image RI is displayed on the graphical user interface.

### TECHNICAL FIELD

The invention relates to a method for monitoring a load compartment in vehicle, and the use of an optical sensor installed in the load compartment, a computer system with software for image processing and a graphical user interface. The invention also relates to a control unit for carrying out the method as well as a vehicle with a control unit.

### BACKGROUND

Load compartments in vehicles are often not fully used, as the operator does not always have complete information about the load state. It is also desirable to carry out load monitoring while travelling.

From DE 10 2006 028 627 A1, a method for load monitoring is known with which image information of the load is captured by means of a camera and evaluated by means of a differential image method. The differential image is shown on a display unit in the vehicle interior.

Camera images of the load or differential images generated from camera images allow a rough estimation of the occupancy of the load compartment and/or the remaining free area in the load compartment. It is often important for the operator to provide information as to whether and to what extent the load compartment is occupied with the usual size units used in transportation and/or with how many size units the load compartment can be additionally occupied. In order to answer this question, the user would have to analyze the captured camera image in an elaborate manner.

### SUMMARY

It is desirable to provide a method by which the occupancy or non-occupancy of the load compartment in predefined size units is possible. Preferably, load monitoring should also be possible.

According to the disclosed method, a grid R of the load compartment is stored in the computer system, that an image I(t₁) acquired by the optical sensor at a time t₁ is converted in the computer system into a grid image RI, which shows the occupancy, non-occupancy, or the change in occupancy of the load compartment according to the stored grid R, and that the grid image RI is displayed on the graphical user interface.

The optical sensor is preferably arranged at the rear and upper center in the load compartment (relative to the driving direction), i.e. with a forward view to an in particular closed front-facing end wall of the load compartment. The access to the load compartment is preferably below the sensor. The accommodated load is positioned at the shortest possible distance from the front-facing end wall of the load compartment. This avoids unoccupied areas that cannot be seen by the sensor.

The grid can divide the floor of the load compartment into areas that can easily be counted by the user, similar to the occupancy of a chessboard, but adapted to a floor area of the load compartment, which is typically of a long and narrow form in a commercial vehicle. Preferably, the grid contains a few rows with many lines, i.e. a single-digit number of rows, especially in the low single-digit range (<5), as well as a single digit number of lines or a number of lines in the low two-digit range (<30).

The grid image can reproduce the grid with different colors, gray tones, or black and white. The occupancy or non-occupancy of the load compartment can then be seen from the colors, shades of grey or the black or white representation. Also, numbers or letters can be entered into the fields of the grid. The grid image provides a quicker and easier overview of the occupancy/non-occupancy of the load compartment than a sensor image.

Preferably, the optical sensor is a camera. However, other optical sensors can also be used, for example with infrared technology or radar technology.

Advantageously, the image captured by the optical sensor in relatively short periods of time will be converted into the grid image and displayed on the user interface. Changes from the last grid image can also be displayed on the user interface. As a result, load monitoring is also possible.

According to a further idea of the invention, the grid R may be adapted to the size and shape of containers or pallets used in particular in the transport sector. For example, a field of the grid can correspond to the dimensions of the Euro pallet, another pallet, a grid box of defined size, the floor area of a carton of defined size, manufacturer-specific containers, or pallets.

According to a further idea of the invention, the grid R may be provided two-dimensionally, i.e. flat. Only an occupied/unoccupied floor area of the load compartment is taken into account. In other words, if there is something in a position, then the entire space above it is also considered occupied. In practice, it is assumed that the floor surface farthest from the optical sensor is occupied first and the area under the optical sensor is occupied last. In the image captured by the optical sensor, the unoccupied surface is visible and normally has a different color or gray value than the containers or pallets on the occupied floor surface. As a result, distinguishing is easily possible.

According to another idea of the invention, the grid R can be three-dimensional, i.e. spatial. The grid then consists of rows (side by side), lines (in series), and layers (on top of each other). The number of layers is preferably in the single range, especially in the low single-digit range (<5). When evaluating the sensor image, it is taken into account how high the goods present in the load compartment are relative to the end wall and to the side walls. On the graphical interface, the different heights can be reproduced with different shades, gray values, numbers, letters, or other characters.

According to a further idea of the invention, the image I(t₁) in the computer system can be compared with a stored image I(t₀) captured at an earlier point in time t₀, wherein a difference image I(t₁−t₀) is generated and converted into a grid image RI(t₁−t₀), and wherein the grid image RI(t₁−t₀) is displayed on the graphical user interface GUI. The image I(t₀) captured at an earlier time to then serves as a reference image and shows either the empty load compartment or the load compartment after the last change or, in general, a last detail of the load compartment. The grid image RI(t₁−t₀) then shows the change of the images as a grid.

According to a further idea of the invention, it may be provided that the grid image RI(t₁) is compared by the computer system with stored grid image RI(t₀) generated at an earlier time to, and that a grid image RI(t₁−t₀) is generated from the comparison and displayed on the graphical user interface (GUI). In this case, it is not the image which was captured at an earlier point in time that is compared, but the grid image which was generated at an earlier point in time. The grid image RI(t₁−t₀) to be displayed is then calculated from two grid images RI(t₁), RI(t₀) and not from a difference image.

According to another idea of the invention, a grid image can be generated incrementally, wherein at time t₀ an image I(t₀), at time t₁ an image I(t₁, and at time t₂ an image I(t₂) is captured, and wherein a difference image I(t₁−t₀) or a grid image RI(t₁−t₀) is generated from the images I(t₀), I(t₁), and a grid image RI(t₂−t₀) is finally generated by additional processing of the image I(t₂). Thus, it is not the first image I(t₀) and the last image I(t₂) which are compared with each other to achieve the grid image RI(t₂−t₀). Rather, it is an incremental process by first comparing the first image I(t₀) with the second image I(t₁) and then the second image I(t₁) with the third image I(t₂). Again, the images can be compared with each other and the desired grid image RI(t₂−t₀) can be generated from the result of all the comparisons. Alternatively, the corresponding grid image can first be generated from each image and then the grid images can be compared with each other. In all cases, the result is the grid image RI(t₂−t₀) which is to be displayed.

The incremental generation of the grid image RI is not limited to three images of the times t₀, t₁, t₂. Rather, a grid image can be generated incrementally from any number of images I(t₀), I(t₁), . . . , I(tₙ). Preferably, after each processing of an additional image, a corresponding grid image RI(t₁−t₀), RI(t₂−t₀), RI(tₙ−t₀) is available for retrieval or is displayed. In this way, a user can track the changing of the grid image on the graphical user interfaces.

During loading and unloading, the image captured by the camera can change continuously, for example by moving a person or a forklift truck. To compensate for this, it may be provided that the images are not recorded as such until they have been unchanged for a defined period of time, for example 1 to 100 seconds. This means that the optical sensor records continuously or in short cycles. If no change can be detected in the period, then an image will be retained for further processing, for example the image I(t₁). After a further defined period of time, for example after 5 to 500 seconds, a next image is then checked to see if it has changed within the last 1 to 100 seconds. If no change has occurred, then this next image is recorded and processed as the image I(t₂). This procedure can be applied in conjunction with all other aspects and is not limited to the incremental generation of the grid image.

According to a further idea of the invention, the grid image RI(t₁) can be calculated from the images of multiple optical sensors installed in the load compartment. For example, two or more cameras each capture an image at time t₁, from which the grid image RI(t₁) is calculated.

According to another idea of the invention, light of an artificial light source can illuminate the load compartment during the capture of the image I. One or more light sources may be provided, also different types, such as visible light, infrared light, flash light. The same lighting conditions for all images are advantageous. In practice, there may be significant differences in brightness without lighting. Thus, a load compartment covered by a bright tarpaulin can be relatively bright in daylight and already much darker in the evening hours.

According to another idea of the invention, the capture of the image I can be triggered by an event detected by sensors. Sensors/detectors or associated signals may be at least the following: an acceleration sensor, a speed signal via a CAN bus, a smoke detector, a liquid detector (especially on the floor), a temperature sensor, a humidity sensor, a condition detector on the vehicle (e.g. doors open/closed).

According to another idea of the invention, the display of the grid image RI on the graphical user interface can be triggered by a sensor-detected event. Suitable sensors/detectors or signals are already mentioned in the preceding section.

According to another idea of the invention, it may be provided that the grid image RI is only stored and/or processed further by the computer system as a valid grid image after the grid image RI is displayed on the graphical user interface and confirmed by an input into a user interface. The user interface can be the graphical user interface or a button or an interface of a different kind.

The object of the invention is also a control unit with interfaces for a camera and a graphical user interface, and with software for carrying out the method according to any one of claims 1 to 12. In particular, it is a brake control unit of an electronic brake system. The interfaces can be wireless or wired. The graphical interface is preferably connected to a computer with suitable software or part of the computer. For example, the computer is a mobile phone or a navigation computer with an app.

The object of the invention is also a vehicle with a control unit as claimed in claim 13. In particular, the vehicle has an electronic brake system with a brake control unit. Preferably, the control unit according to the invention is the brake control unit of the electronic brake system. The vehicle is, in particular, a commercial vehicle, such as a tractor unit, a trailer or a semi-trailer.

Otherwise, further features of the invention result from the description and from the claims. Advantageous exemplary embodiments of the invention are explained in more detail below on the basis of drawings.

### BRIEF DESCRIPTION OF THE DRAWINGS

In the drawings,

FIG. 1 shows a schematic representation of a commercial vehicle, namely a tractor unit with a semi-trailer,

FIG. 2 shows a first grid image in a 3-by-11 grid,

FIG. 3 shows a second grid image in a 2-by-17 grid, and

FIG. 4 shows a flowchart illustrating the method for monitoring the load.

### DETAILED DESCRIPTION OF THE DRAWINGS

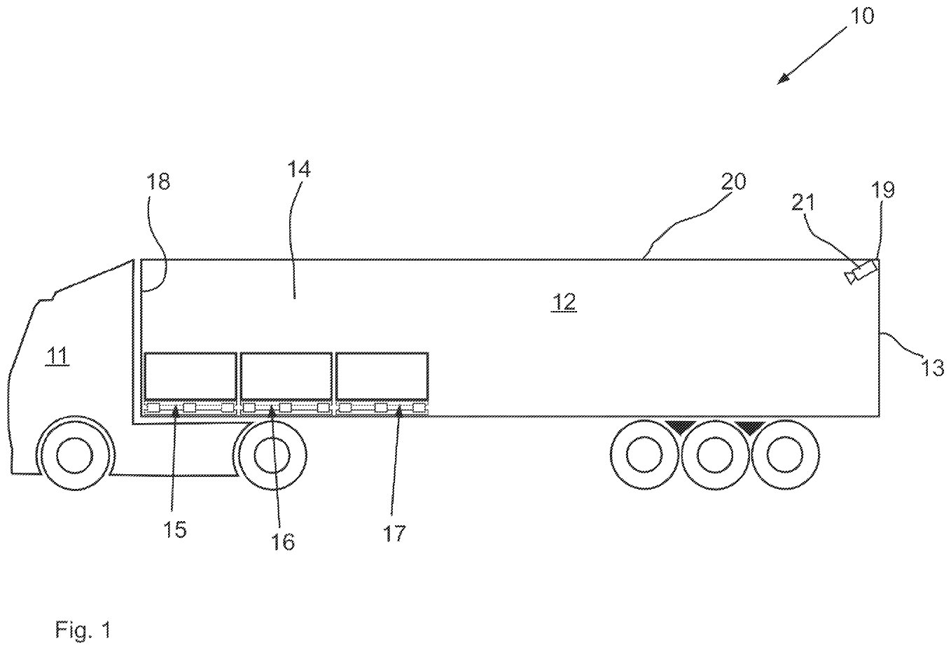

A commercial vehicle 10 shown in FIG. 1 consists of a tractor unit 11 and a semi-trailer 12. The semi-trailer has a load compartment 14 which is particularly accessible from its rear-facing end wall 13 or from the side.

In the load compartment 14, three line 15, 16, 17 of pallets are arranged in series in the direction of travel, namely starting from a front-facing end wall 18.

A camera 21 is arranged centrally (relative to the width of the semi-trailer 12) as an optical sensor at the top of the rear-facing end wall 13 in the area of an angle 19 to an upper wall 20. The camera 21 is directed down at an angle and is intended to capture the load compartment 14 as completely as possible. Alternatively, multiple cameras may be provided.

The semi-trailer 12 has an electronic brake system in a known manner. A brake control unit or other computer system which is not shown receives the images of the camera 21 and generates grid images RI from these, from which the occupancy of the load compartment 14 can be recognized by using a grid R.

The grid R for the load compartment 14 is stored in the computer system. Advantageously, the grid R is based on the proportions of the transport aids used. Containers, pallets, or other aids are used here as transport aids, which can be used to group or contain goods and the dimensions of which are standardized. In this example, so-called Euro pallets are provided, with external dimensions 1200 mm×800 mm (also known as Euro Pool pallets). These have the advantage that two pallets in the longitudinal direction take up the same length as three pallets in the lateral direction.

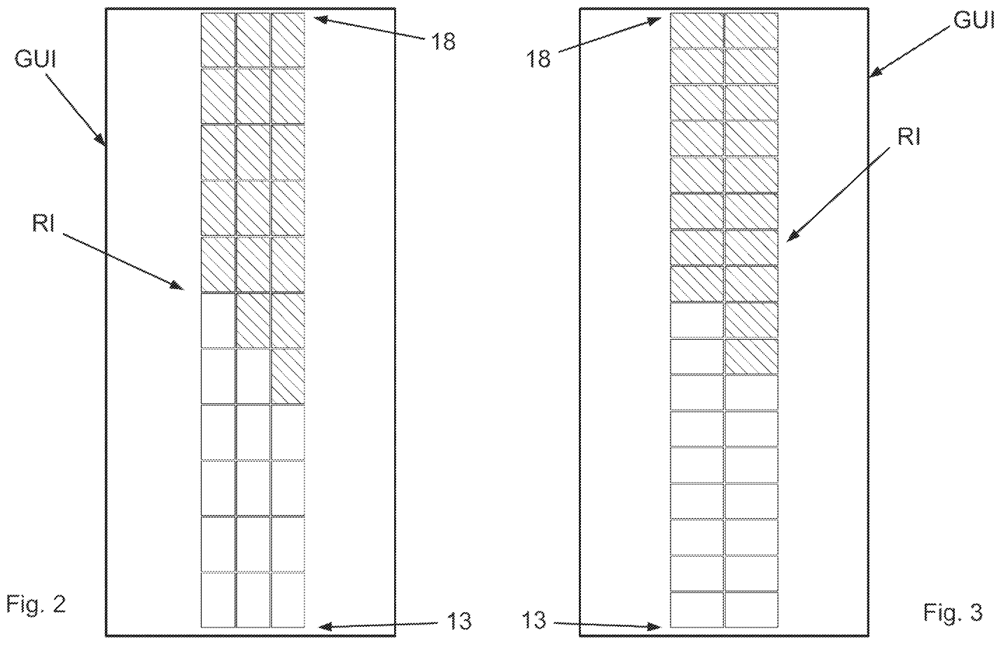

FIG. 2 shows a grid image RI of the load compartment 14 with a grid with pitching with 3 rows by 11 lines. According to the example in FIG. 2, five lines of the grid are fully occupied. A sixth line is occupied at ⅔ and a seventh line is occupied at ⅓, which is different from FIG. 1. The grid image in FIG. 2 was generated from an image of the camera 21 in the computer system by image processing, matching with the empty load compartment and comparison with the 3×11 grid provided here. The RI grid image is displayed for the user on a graphical user interface GUI, for example on a screen of his navigation device or the display of his mobile phone in conjunction with an app.

By comparing or adjusting the image captured by the camera to the grid R, the grid image can in practice represent the situation differently from the image of the camera, for example if different transport aids (palettes, etc.) and/or smaller transport aids are used than would correspond to the grid. Preferably, therefore, the grid R is variable or can be set or preset by the user.

FIG. 3 shows a grid image of another grid R, namely for a grid with a pitch with 2 rows by 17 lines. Again, it is preferably a pitch according to the dimensions of Euro palettes.

In the example of FIG. 3, full occupancy of the first eight lines (starting from the front-facing end wall 18) and half occupancy of the two adjoining lines can be seen from the grid image. The remaining places in the grid are free and can still be occupied.

Two questions are of particular importance to the user:

1. Information about the current load state without the need for inspection of the load compartment;

2. Information about a change in the load state during periods in which a change is not expected, i.e. in particular in the case of an unopened load compartment, during travel and/or outside defined working hours.

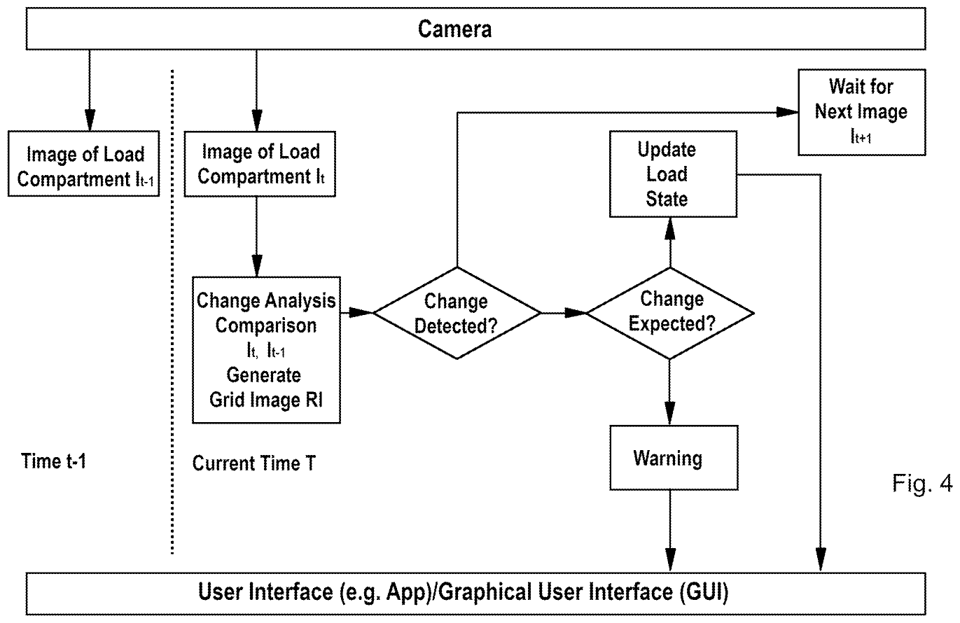

In FIG. 4, the process of the load compartment monitoring by image processing is illustrated:

At a current time t, an image Iₜ of the load compartment is captured and compared with an image Iₜ₋₁ previously captured during a time t−1. A grid image RI is generated from the comparison. In the grid image RI a change of the image Iₜ to the image Iₜ₋₁ is shown, for example by gray values, colors, symbols, or hatching. If the two images match, no further action will take place. Instead, the arrival of the next image Iₜ₊₁ is awaited.

If the images Iₜ and Iₜ₋₁ do not match, a change in the load is assumed and a check is carried out as to whether a change was expected. Criteria for this may include defined working hours, the speed and/or the state of a door of the load compartment (open or closed). In the event of the vehicle being at a standstill and the door being open during normal working hours, a change in the load state is expected and the calculated grid image RI is provided via a user interface, in particular displayed on a display.

If a change in the load state is not expected, a warning is issued via the user interface, such as an audible or visible signal. In addition, the calculated grid image RI is displayed. The user now has the option to acknowledge the issued warning using the user interface and to check the load compartment.

The camera 21 in the load compartment captures images consisting of individual pixels. When comparing images Iₜ, Iₜ₋₁, the respective pixels are compared with each other. Even small differences in the orientation of the camera 21 lead to deviations of all pixels, for example due to vibrations while travelling or during the loading process. Preferably, therefore, a so-called alignment takes place before comparison of the images. This means that the images are aligned to each other pixel-precisely. This is possible and known by means of image processing in software.

What is claimed is:

1. A method for monitoring a load compartment (14) in a vehicle (10), using an optical sensor (21) installed in the load compartment (14), a computer system with software for image processing and a graphical user interface (GUI), the method comprising the following steps:
storing a grid R of the load compartment (14) in the computer system,
storing an image I(t₁) captured by the optical sensor (21) at a time t₁;
converting the image I(t₁) t₁ is in the computer system into a grid image RI which shows an occupancy, non-occupancy or change in occupancy of the load compartment (14) according to the stored grid R, and
displaying the grid image RI on the graphical user interface (GUI).

2. The method as claimed in claim 1, wherein the grid R is adapted to a size and shape of containers or pallets.

3. The method as claimed in claim 1, wherein the grid R is two-dimensional.

4. The method as claimed in claim 1, wherein the grid R is three-dimensional.

5. The method according to claim 1, wherein the conversion of the image into the grid image is performed by comparing the image I(t₁) in the computer system with a stored image I(t₀) captured at an earlier time t₀, that a difference image I(t₁−t₀) is generated and is converted into a grid image RI(t₁−t₀) and that the grid image RI(t₁−t₀) is displayed on the graphical user interface.

6. The method according to claim 1, further comprising the steps of comparing the grid image RI(t₁) with a stored grid image RI(t₀) generated at an earlier time t₀,
generating a grid image RI(t₁−t₀) from the comparison, and
displaying the grid image RI(t₁−t₀) on the graphical user interface (GUI).

7. The method according to claim 1, wherein the grid image (RI) is generated incrementally by wherein
capturing an image I(t₀) at a time t₀,
capturing the image I(t₁) at the time t₁, and
capturing an image I(t₂) at a time t₂,
generating a difference image (t₁−t₀) or a grid image RI(t₁−t₀) from the images I(t₀) and I(t₁), and
finally generating a grid image RI(t₂−t₀) by processing the image I(t₂).

8. The method according to claim 1, wherein the grid image RI is calculated from images of multiple optical sensors (21) installed in the load compartment (14).

9. The method according to claim 1, wherein an artificial light source illuminates the load compartment during the capture of the image I.

10. The method according to claim 1, wherein the capture of the image I is triggered by an event detected by sensors.

11. The method according to claim 1, wherein the display of the grid image RI on the graphical user interface (GUI) is triggered by an event detected by sensors.

12. The method according to claim 1, wherein the grid image RI is only stored by the computer system as a valid grid image or further processed after the grid image RI has been displayed in the graphical user interface (GUI) and confirmed by an input into a user interface.

13. A control unit comprising interfaces for an optical sensor and a graphical user interface (GUI), and with software for carrying out a method according to claim 1.

14. A vehicle comprising a control unit as claimed in claim 13.
